(19) United States
(12) Patent Application Publication
(10) Pub. No.: US 2012/0090216 A1
(43) Pub. Date: Apr. 19, 2012

(54) Electronic Firearm Sight and method for adjusting the reticle thereof

(76) Inventor: Danyun Li, Nantong (CN)

(21) Appl. No.: 12/911,525

(22) Filed: Oct. 25, 2010

(30) Foreign Application Priority Data
Oct. 19, 2010 (CN) 201010511597.8

(51) Int. Cl. F41G 1/38; G06F 3/041; G06F 19/00

(52) U.S. Cl. 42/122; 235/404; 345/173

(57) ABSTRACT

An electronic firearm sight comprises a set of zoom lens, an image sensor, a processor, a memory, and a touch display screen for the operation of adjusting and determining a reticle. A method for adjusting the reticule comprises the following steps: displaying a coordinate on the touch display screen, setting the origin of the coordinate at the center of the touch display screen, aiming at an object with the origin, firing the first bullet to get the first bullet hole on the touch display screen, obtaining the coordinate value of the first bullet hole, determining the opposite valu, clicking on the place of the opposite value, moving the origin of the coordinate to the place of the opposite value, and aiming at the object with the new origin, firing the second bullet to get the second bullet hole, removing the coordinate; clicking the second bullet hole, an adjusted reticle appearing.

### BACKGROUND

1. Field of the Invention

The present invention relates to the field of firearm sights, more particularly, to an electronic firearm sight with a touch display screen, which allows the shooter to adjust the reticle on it.

2. Brief Description of Related Arts

Over times, people invented a variety of instruments and devices to help shooters to aim at a target. In general, the conventional sighting devices used in firearms can be categorized into telescopic sight, reflex sight and other sights based upon different principles.

To achieve the goal of aiming at a potential target accurately, rapidly and conveniently, a reticle is a very important factor to locate the target. Other auxiliary aides, such as measuring the range, can be also used. However, the design and usage of current reticles have many disadvantages. The existing firearm sight, including the two types described above and an electronic sight uses two devices to adjust the reticle. One is controlling the reticle to move vertically so as to make it superimposed on the bullet's impact point, namely up and down; the other is controlling the reticle to move horizontally, namely left or right. However, these adjusting methods have the following shortcomings:

On the one hand, the existing sight, either mechanically or electronically, all set two buttons or knobs to make the reticle move. With this design, not only the errors of the two parts themselves, but also their wearing out could cause inaccuracy to adjusting the reticle. On the other hand, these devices all preset a rated value as a moving scale. The moving unit is rated, which represents a fixed value of the movement of the reticle. However, a certain bullet impact point t does not have to be one of these fixed moving scales; as a result, the reticle can only be superimposed on the bullet's impact point approximately, but can not fulfill the full superimposition theoretically. In practice, the shooter could encounter a target at the range of more than one thousand yards, but usually the superimposition of the impact point and the reticle can only be done within a very short distance, such as one hundred yards. Therefore, once the distance is over one thousand yards, the error value of the approximate superimposition will be quite big, which brings a lot of inconvenience to firing if highly accuracy is required

A telescopic sight can only use one reticle shape, which causes big limitation to shooting, because the different types of firearms, bullets, and shooting environments in practical shooting have different ballistic trajectory. Usually, the reticle image used in a reflex sight is just one red or bright orange light spot. Sometimes, a cross line, a light ring or other shapes are even used. Their principles simply can not be adopted to set a reticle scale based on ballistic trajectory. In current electronic sights, the design of a reticle also follows the traditional one, at most presetting or downloading some reticles, but never mentioning about how to adjust a suitable reticle according to different ballistic trajectories of different bullets. One thing is needed to point out is that because the reticle in these electronic sights are either downloaded from internet or designed by the user through computers, if the user does not have correct knowledge about ballistics, he or she probably will choose or design an incorrect reticle, and directly lead to incorrect settings to the sight.

Another important factor of affecting aiming accuracy is a clear view even in an environment with low intensity illumination. However, current electronic sights have no any solution for the problems. As for telescopic sights and reflex sights, the limitation of optical theory does not allow the sight to capture good quality images in the circumstances of low intensity illumination.

### SUMMARY OF THE PRESENT INVENTION

One objective of the present invention is to provide an electronic firearm sight, which has a touch display screen used for adjusting and determining an accurate and proper reticle, so as to overcome the shortcoming of current technology.

According to the present invention, the electronic firearm sight comprises a set of lens for capturing the optical image of an aimed object, an image sensor for converting the optical image into electronic signals, a processor for receiving the electronic signals from the image sensor and processing them and other data, a memory for storing different programs and data, and a touch display screen for the operation of adjusting and determining a reticle, once having received operation instructions from users, the touch display screen sending the corresponding information to the processor, and receiving and executing commands from the processor.

There are pre-saved data or information in the memory of a Cartesian coordinate system, ballistic trajectory data of different bullets, and different reticle scales based on the different trajectory data, and even different colors and shapes of the reticle scales. These data or information is presaved to determine a proper and accurate reticle.

Moreover, in order to overcome the problem of not being able to view clearly long distance objects of existing sights, a set of zoom lens are used. The creative combination of zoom lens and the image sensor allows the long distance object display very clearly on the screen, which not only gets the traditional telescopic sight out of turning the magnifying ratio ring to enlarge images, but also fills in the blank of existing electronic sights, which use the digital magnification with the most magnification ration of 4×.

In addition, the present invention further comprises a rangefinder, which is for detecting and measuring the distance between the aimed objects and the sight itself, and transmitting corresponding data to the processor. These data are used, as one of parameters, for the processor to analyze the location of a bullet impact point and the reticle.

Likewise, the present invention further comprises a wind speed & direction sensor connected with the processor for detecting the speed and direction of wind, to detect the crosswind and the wind speed, and transmitting corresponding data to the processor. These data are used, as one of parameters for the processor to analyze the location of the impact point and the reticle.

Another objective of the present invention is to provide a touch display screen used for adjusting the reticle of a firearm sight described above. The touch display screen comprises a touch screen, a display and a display driver. The touch screen comprises a touch detection part and a touch controller. the touch display screen is connected with a processor, which in turn is connected with a memory; the memory has presaved a Cartesian coordinate system, ballistic trajectory data based on different bullets, and reticle shapes based on the trajectory data of different bullets; once having received operation instructions from users about adjusting the reticle, the touch display screen sends corresponding information to the processor; once the processor finishing data analysis and forming commands, the touch display screen receives the commands and executes them.

Moreover, the touch display screen is connected with an operation panel. On the operation panel are set operation buttons for controlling the Cartesian coordinate system and reticle scales of the trajectories formed based on different bullets, locking the image of aimed objects, and zooming in or out the image.

Another objective of the present invention is to provide a method of using the touch display screen described above to adjust and determine the reticle of an electronic firearm sight, so as to overcome the shortcomings of current technologies, which preset a rated value as the basic value per unit movement of the reticle.

According to the present invention, the method comprises the following steps:

setting an object to fire;

calling up a Cartesian coordinate system saved in a memory to the touch display screen, superimposing the Cartesian coordinate over the image of the object, and setting the origin of the coordinate at the center of the touch display screen;

viewing the image of the object through the touch display screen, and aiming at the object with the origin of the coordinate;

firing the first bullet toward the object to get a bullet hole on it and viewing the corresponding scene through the touch display screen;

locking the scene;

finding the corresponding place of the first bullet hole appearing on the touch display screen;

obtaining the coordinate value of the corresponding place of the first bullet hole appearing on the touch display screen;

determining the opposite value, on the touch display screen, of the coordinate value of the corresponding place of the first bullet hole;

clicking on the place of the opposite value on the coordinate of the screen so as to move the origin of the coordinate to the place of the opposite value;

unlocking the scene;

aiming at the object with the new origin of the moved coordinate;

firing the second bullet, thereby the corresponding place of second bullet hole appearing on the touch display screen;

locking the scene again;

removing the coordinate from the touch display screen;

clicking on the corresponding place of the second bullet hole on the touch display screen, thereby a reticle appearing;

unlocking the scene.

Moreover, the method described above further comprise the steps, after determining the place of the reticle, that choosing a proper reticle shape based on the bullet type, the color and brightness of the reticle, and the requirement for lines. These steps can be operated through an operation panel.

The present invention has the following advantages.

By providing the firearm sight with a touch display screen and a new method of applying the touch display screen to adjusting and determining the reticle, the users can simply click the actual bullet's impact point displayed on the screen, instead of using the rated movement scale of the reticles of the existing technologies. Therefore, it can fulfill real accurate superimposition of a reticle and a bullet impact point, and eventually improve the aiming accuracy greatly;

By applying zoom lens to the electronic firearm sight, the optically amplified object can be displayed very clearly on the screen, thereby opening up a new time of big magnification sight. It is incredible to use a sight with the magnification rate of 36×, or even 100× in the practical shooting, compared to the at most 4× digital zoom of current electronic firearm sights and at most 8× of telescopic sights.

It is worth mentioning that by adding a rangefinder and a wind speed & direction sensor to the sight, plus the different trajectory data pre-saved in the memory, the real automatic aiming can become real, and even a shooter with poor skills can hit an object accurately.

### BRIEF DESCRIPTION OF DRAWINGS

FIG. 1 is the structural block diagram of a firearm sight with a touch display screen of the present invention.

FIG. 2 is the structural block diagram of an embodiment of the firearm sight of the present invention.

FIG. 3 is a diagrammatic view of an operation panel, which is a component of the sight of FIG. 2.

FIG. 4 is the schematic diagram of a touch display screen of the present invention.

FIG. 5 is the flow chart of the method of the present invention.

FIG. 6-FIG. 11 are schematic diagrams of modifying the place of an impact point, which appears on the touch display screen, by way of a Cartesian coordinate system.

### DETAILED DESCRIPTION OF PREFERRED EMBODIMENTS

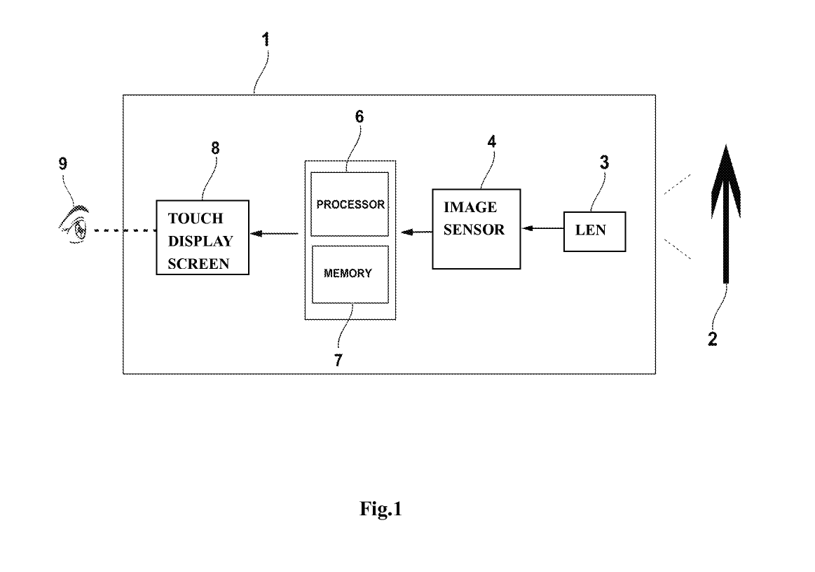

As shown in FIG. 1, an electronic firearm sight 1 comprises a set of optical lens 3, which captures the image of an object 2, an image sensor 4 connected with the set of optical lens 3, which converts lights into charges, a processor 6 connected with the image sensor 4, which processes the image from the image sensor 4, a memory 7 connected with the processor 6, which stores a variety of information ready to be processed or having processed by the processor, and a touch display screen 8, which receives operation instructions given by a user 9 and sends corresponding information to the processor, the processor analyzing and processing the information, and then sending it back to and having it displayed on the touch display screen.

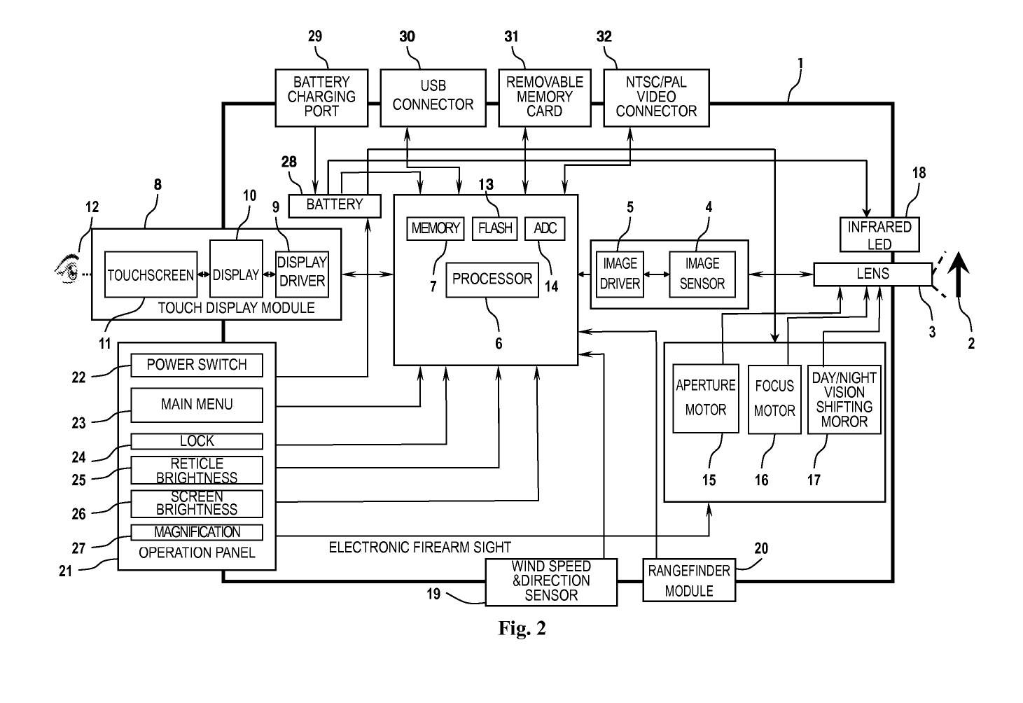

Referring to FIG. 2, The lens 3 is a multiple of zoom lens, which can change the focus through changing the relative places of the lens, so that make the views at distance clearer. The lens 3 could be wide-angle lens, standard lens, telephoto lens, or fixed focal length lens (FFL), or other lens made according to specific requirements of the sight. The lens includes other components, such as an aperture motor 15 for adjusting the aperture, a focus motor 16 for adjusting the focus, and a day/night vision shifting motor 17. Other lens components could be added. When an infrared led 18 is added to the lens, the day/night vision shifting motor 17 converts to the mode of might vision, so that the sight can be used at night.

According to different demands, the image sensor 4 can be charge-coupled device array (CCD array), complementary metal oxide semiconductor (CMOS), or other types.

Referring to FIG. 2, the processor 6 is connected through ADC 14 with an image driver 5 and the image sensor 4, so that ADC 14 converts the electrical signals of an image into digital signals. The processor 6 includes an image-processing chip to restore digital signals to an optical image, to superimpose an adjusted reticle on it, and to display the superimposed image on the touch display screen. The processor 6 is also connected with a Flash 13, which stores program codes.

The memory 7 mentioned above is a RAM, in the present embodiment.

Referring to FIG. 2 and FIG. 4, the touch display screen 8 comprises a touch screen 11, a display 10 and a display driver 9. The touch screen 11 is connected with the processor through the display 10 and a display driver 9.

As shown in FIG. 2, a rangefinder 20 and a wind speed & direction sensor 19 are connected with the processor 6. The rangefinder 20 is used to measure the distance between the object 2 and the sight 1 when the user has locked the object, through laser, ultrasonic, red infrared ray or other chips of measuring distances, and then to send corresponding data to the processor 6. The wind speed & direction sensor 19 has a chip for detecting the wind speed, delivering real-time wind speed to the processor. Therefore, after comparing the ballistic trajectory data, the processor 6 can calculate a new impact point and corresponding reticle place. For example, according to pre-saved data, a bullet drops 4 cm at the distance of 500 meters, and the real-time crosswind speed is 6 m/s which cause the bullet to move left by 3 cm. Thus, modify the deviation resulted from the drop of the bullet and wind speed, based on the pre-saved data. After getting the new impact point, show the new place with the modified reticle on the screen.

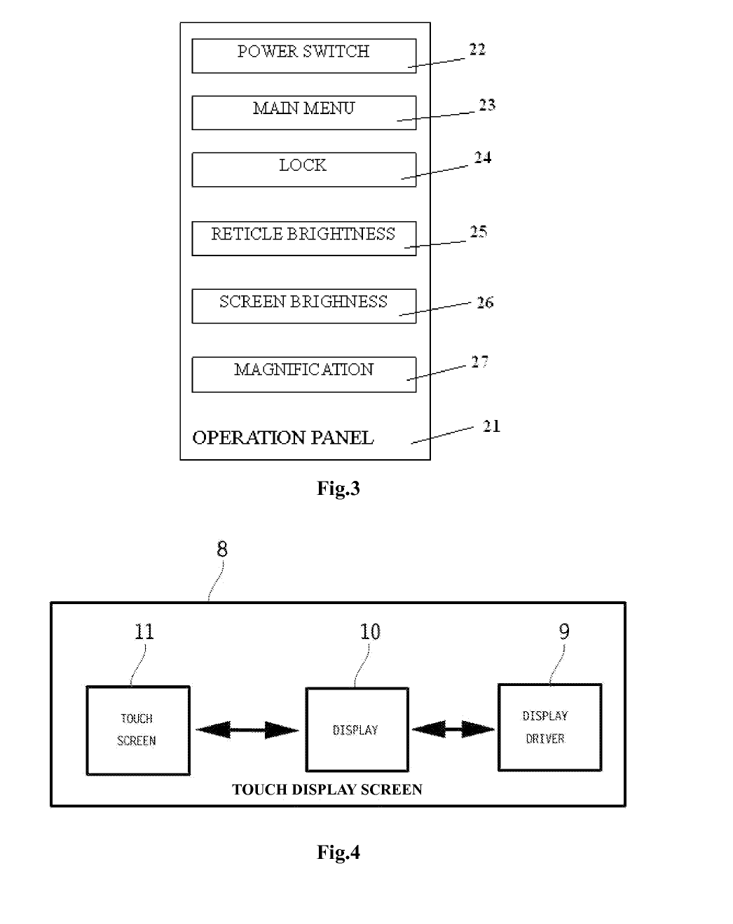

As shown in FIG. 2 and FIG. 3, the sight has an operation panel 21 consisting of six function buttons, power switch 22, main menu 23 lock 24, reticle brightness 25, screen brightness 26, and magnification 27. The power switch 22 is connected with a battery 28, which provides electrical source and can be charged through a battery charging port 29. The lock button 24 is for locking the image of an aimed object. When the user needs to view and measure the impact point after firing a bullet, the lock button needs to be pressed. The magnification function 27 is used to magnify or reduce the image of the object displayed on the display screen. The main menu 23 includes the following options, coordinate, reticle, rangefinder, wind speed &direction, and recorder. After clicking on the reticle option, its sub-interface is popped up, which includes settings of various parameters, such as reticle type, reticle line, reticle color, and reticle shape, and et.; For example, the reticle type includes general reticle, bullet drop compensation reticle, and specially made reticle.

The sigh is also provided with a USB connector 30, a removable memory card 31 and a video connector 32.

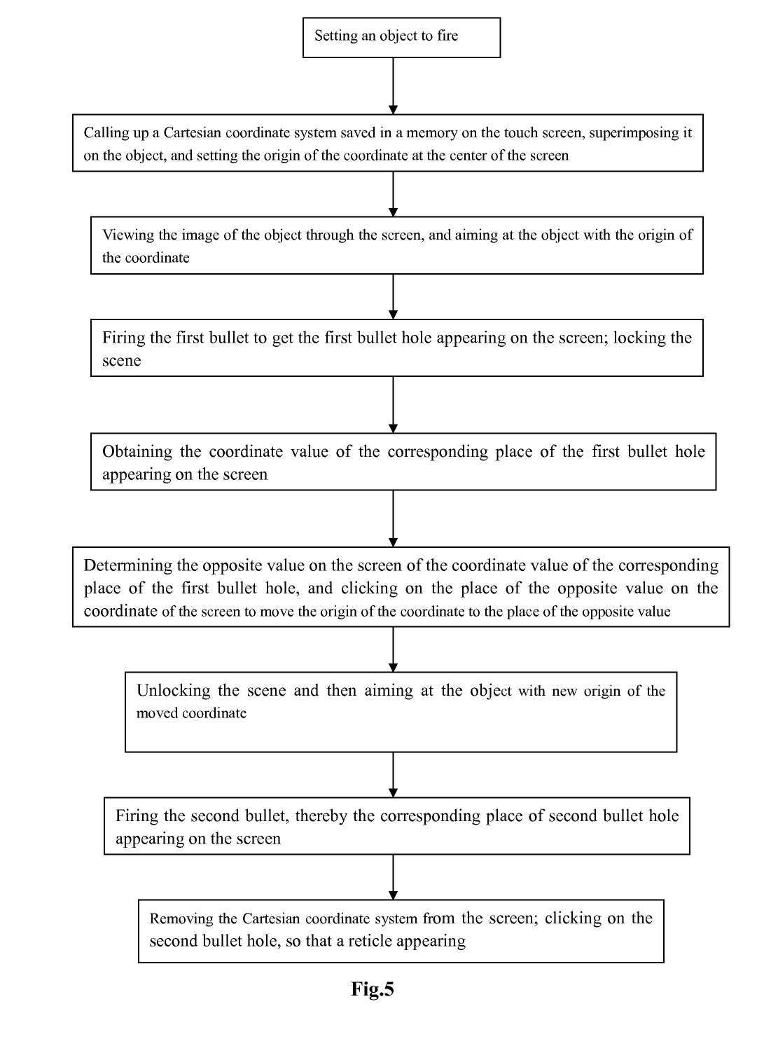

FIG. 5 is the flow chart of the method of the present invention. The following

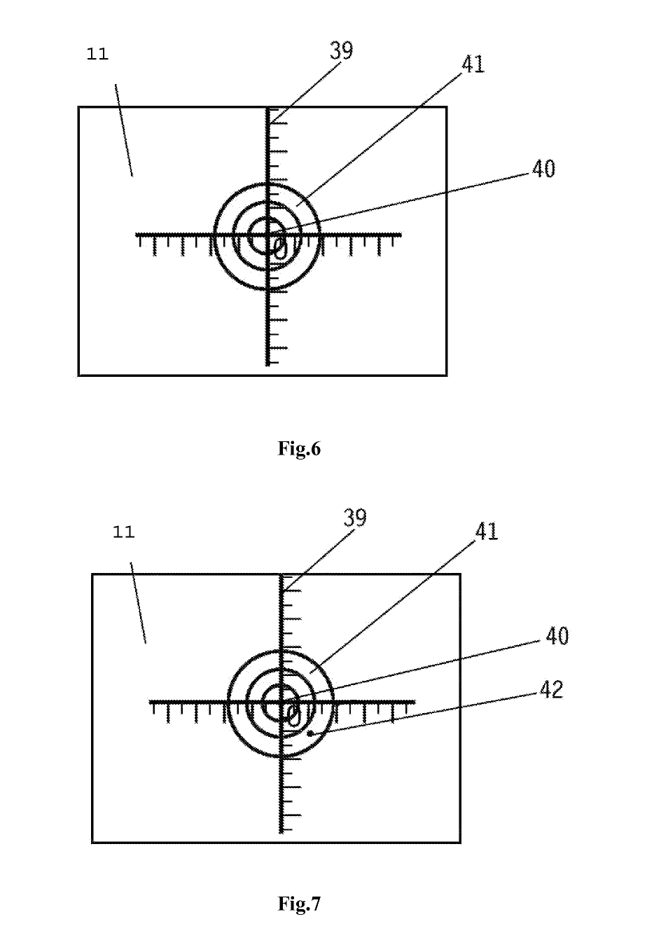

Referring to FIG. 5, and FIG. 6-FIG. 11, an embodiment of the method of using the touch display screen to determine a proper reticle is described as follows.

First, an object is set at a certain distance from the sight. As shown in FIG. 6, when pressing the menu button on the operation panel of the sight, and further clicking the coordinate option, a coordinate 39 appears on the touch screen 11. Set the origin 40 of the coordinate at the center of the screen, which is the intersection of the diagonal of the screen. The user can view the image 41 of the object through the screen, and aim at the image 41 with the origin 40 of the coordinate 39.

Next, fire the first bullet, and accordingly get the first bullet hole 42, which is displayed on the screen, as shown in FIG. 7. Press the lock button on the panel to lock the instant scene.

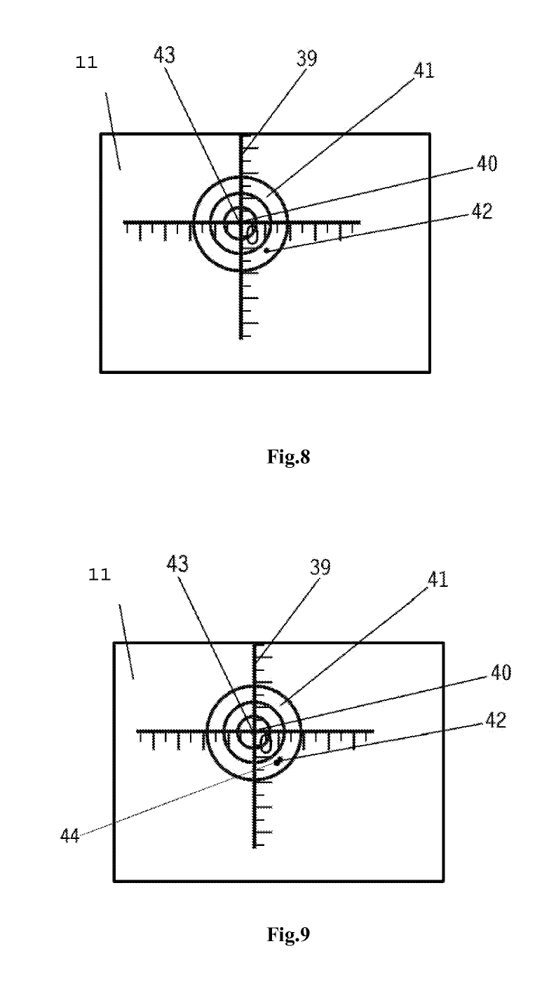

Referring to FIG. 8, read the value from the coordinate the first bullet hole 42 on the screen, and find the opposite value 43 at the coordinate. Click the opposite value 43, so that the coordinate 39 is moved to the place where the opposite value 43 is. By doing so, the coordinate 39 has been moved from the center of the screen to the place 43 of the opposite value of the actual bullet impact point. Then, press the lock button on the operation panel to unlock the scene, and aim at the image 41 with the new origin of the moved coordinate again, which is the place of the opposite value 43. Now the impact point, which was not at the center of the screen, appears at the center of the screen and the previous origin of the coordinate before being moved, which was at the center of the screen, has been moved out from the center.

Referring to FIG. 9, now the user can fire the second bullet and get the second bullet hole 44. The second bullet hole 44 appears at the center of the screen and, theoretically, it will be superimposed with the first bullet hole 42. Lock the instant scene again.

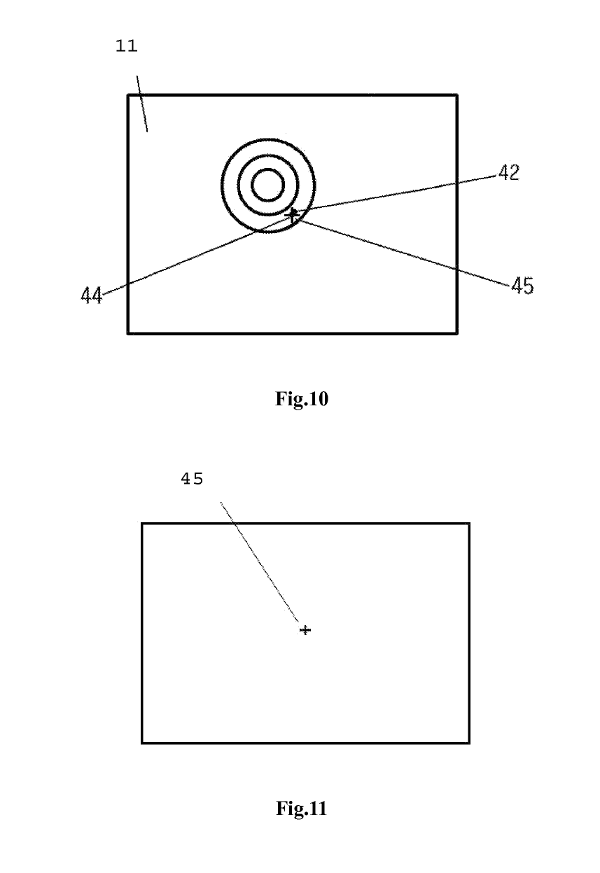

Referring to FIG. 10, remove the coordinate, and click on the second bullet hole 45 on the screen, the figure of a reticle 45 appears at the place. Then, unlock the instant scene.

Referring to FIG. 11, based on the place of the reticle of last step, the user can modify the reticle with a certain shape, color, line, brightness of the reticle and the screen through the operation panel to get a suitable reticle. For example, the user can choose a suitable color for the reticle in order to make the reticle outstanding in the environment background.

The embodiment described above is to adjust the bullet impact point so as to be located at the center of the screen. If hoping the reticle to appear at any desired place, instead of the center of the screen, the user, after getting the first bullet impact point, simply just finds the opposite value of an adjusted amount the user desires and aims at the opposite value with the new origin of the moved coordinate. Then fire the second bullet to get the second bullet hole, which is at the ideal place of the screen. Finally, click on the second bullet hole on the screen and a reticle at the ideal place appears.

Therefore, within the range the screen can display, the user can adjust the reticle until the reticle appears at a desired point.

Because of the brand-new adjusting method, the user can make the impact point return to the origin at any distance and in any shooting circumstances, which makes the task of time consuming, bullet consuming, and rarely being done with accuracy be easier.

What is claimed is:

1. An electronic firearm sight, comprising:
a set of lens for capturing the optical image of an aimed object;
an image sensor for converting the optical image into electrical signals;
a processor for receiving the electrical signals from the image sensor and processing them and other data;
a memory for storing different programs and data which are for the processor to use; and
a touch display screen for operation of adjusting and determining a reticle, once having received operation instructions from users, the touch display screen sending the corresponding information to the processor, and receiving and executing commands from the processor.

2. The electronic firearm sight set forth in claim 1, further comprises a rangefinder connected with the processor for measuring the distance between the aimed object and the firearm sight itself, and sending corresponding data to the processor, as one of analytic parameters of an impact point.

3. The electronic firearm sight set forth in claim 1, further comprises a wind speed & direction sensor connected with the processor for detecting wind speed and wind direction, converting into electronic data, and sending the electronic data to the processor, as one of analytic parameters of an impact point.

4. The electronic firearm sight set forth in claim 1, wherein the set of lens is a set of zoom lens.

5. The electronic firearm sight set forth in claim 1, wherein the data in the memory includes data of a Cartesian coordinate system, ballistic trajectories of different bullets, and different reticle scales formed based upon the ballistic trajectories; the data is presaved in the memory.

6. The electronic firearm sight set forth in claim 5, further comprises an operation panel connected through a general purpose I/O port with the processor;
the operation panel is provided with buttons for controlling the Cartesian coordinate system and the reticle shapes, locking the scene of the aimed object, zooming in and zooming out the image of the object.

7. The electronic firearm sight set forth in claim 1, wherein the processor is connected through an Analog-to Digital Converter with the image sensor to convert the electrical signals of an image into digital signals; the processor includes an image-processing chip for restoring the digital signals to an optical image.

8. The electronic firearm sight set forth in claim 1, wherein the touch display screen comprises a touch screen, a display, and a display driver; the touch screen is connected through the display and display driver with the processor.

9. A touch display screen used for adjusting and determining the reticle of an electronic firearm sight, comprising:
a display
a touch screen installed in front of the display; and
a display driver;
the touch display screen is connected with a processor, the processor in turn is connected with a memory;
the memory is provided with pre-saved data of a Cartesian coordinate system, ballistic trajectory data of different bullets and reticle scales formed based on different ballistic trajectories of different bullets;
the touch display screen receives operations of adjusting the reticle from a user and sends corresponding information to the processor;
the processor analyzes the information through using the pre-saved data in the memory, forms commands, and sends the commands to the touch display screen to execute.

10. The touch display screen used for adjusting and determining the reticle of an electronic firearm sight set forth in claim 9, wherein the processor is connected with an operation panel;
the operation panel is provided with buttons for controlling the Cartesian coordinate system and the reticle shapes, locking the scene of the aimed object, zooming in and zooming out the image of the object.

11. A method of using the touch display screen claimed above to adjust and determine the reticle of an electronic firearm sight, comprising:
setting an object to fire;
calling up a Cartesian coordinate saved in a memory to the touch display screen, superimposing the coordinate over the image of the object, and setting the origin of the coordinate at the center of the touch display screen;
viewing the image of the object through the touch display screen, and aiming at the object with the origin of the coordinate;
firing the first bullet toward the object to get the first bullet hole on it and viewing the scene through the touch display screen;
locking the scene;
finding the corresponding place of the first bullet hole appearing on the touch display screen;
obtaining the coordinate value of the corresponding place of the first bullet hole appearing on the touch display screen;
determining the opposite value, on the touch display screen, of the coordinate value of the corresponding place of the first bullet hole;
clicking on the place of the opposite value on the coordinate of the screen so as to move the origin of the coordinate to the place of the opposite value;
unlocking the scene
aiming at the object with the new origin, which means putting the place of the first bullet hole at the center of the touch display screen;
firing the second bullet, thereby the corresponding place of second bullet hole appearing on the touch display screen;
locking the scene again;
removing the Cartesian coordinate from the touch display screen;
clicking on the corresponding place of the second bullet hole on the touch display screen, thereby a reticle appearing;
unlocking the scene again.

12. The method of using the touch display screen claimed above to adjust and determine the reticle of an electronic firearm sight set forth in claim 12, further comprises:
after determining the place of the reticle, choosing a proper reticle based on bullet types and requirements for the shapes and lines from the touch display screen.
